(19) United States
(12) Patent Application Publication
(10) Pub. No.: US 2010/0090470 A1
(43) Pub. Date: Apr. 15, 2010

(54) Stationary wind or fluid scoop which captures and redirects wind or fluid for generating power

(76) Inventor: Basil Eric Blank, Ithaca, NY (US)

Correspondence Address: Basil Blank, 4583 State Route 414, Beaver Dams, NY, 14812, US

(21) Appl. No.: 12/250,882

(22) Filed: Oct. 14, 2008

(51) Int. Cl. F03D 9/00

(52) U.S. Cl. 290/55

(57) ABSTRACT

Stationary wind or fluid scoop which captures and redirects wind or fluid and forces the wind or fluid into a duct or chamber which feeds one or more air or fluid powered generators to convert wind or fluid energy into electrical or mechanical energy. The wind or fluid scoop can be mounted at any angle on existing structures or can stand alone. The wind or fluid scoop can have dynamic louvers which allow wind or fluid to enter the wind or fluid scoop duct or chamber, but can also prevent wind or fluid from exiting the chamber. If used for wind the scoop can utilize turbulent wind around buildings by capturing the wind and redirecting it into an air duct which supplies air to convert wind energy into electrical or mechanical energy. Similar applications for other fluids.

### BACKGROUND OF THE INVENTION

1. Technical Field of the Invention

The present invention relates generally to energy conversion devices, which redirect wind or fluid power to convert wind or fluid energy into electrical or mechanical energy.

2. Description of Related Art

Related prior art, have the disadvantage that they are large, expensive, and are not able to take advantage of turbulent winds. These winds are commonly found around structures and closer to ground level.

Wind power dates back many centuries. Current wind power is used to drive conventional wind mills which are extremely large. Disadvantages to this type of wind power is expense, noise, unsightly and are having a negative impact on wildlife from migrating birds to bats. Previous art also can only be placed in certain areas and are unattainable to the average homeowner or anyone in the city for personal use.

Conventional wind mills are typically nearly inaccessible making them difficult to maintain.

Hydro power has also existed for many centuries. It supplies a large amount of the world's electric supply. There are some disadvantages to it though, the facilities cover huge areas flooding it and in doing so damaging the ecosystem in the area.

To have something that can be used on a small scale for a personal level without much impact on the environment and that is easily removable is a better alternative to the large reservoirs that are created for hydropower today.

### SUMMARY OF THE INVENTION

The uniqueness of this invention is an unconventional wind or fluid collection and redirection chamber. This chamber allows collection of turbulent wind or fluid. This chamber can be altered to fit many wind or structure application from small to large. The idea is to collect wind or fluid and redirect it in a manner that utilizes a chamber design which redirects the wind or fluid into an air or fluid duct which supplies air or fluid to convert wind or fluid energy into electrical or mechanical energy. This invention can supply air or fluid to single or multiple generators. This invention can be mounted on houses or buildings making generator maintenance much easier. The air or fluid duct can be any shape, size or length which would allow the generator to be placed in the most advantageous place for maintenance.

This invention comprises of a single optimized stationary wind or fluid scoop which redirects wind or fluid direction and force for generating power with the option of adding on one or more boosters. The boosters will comprise of the same basic shape and size of the stationary wind or fluid scoop which redirects wind or fluid direction and force for generating power except the booster will only have the ability to rotate a shaft. This shaft will be connected to the generator or connected to a booster between itself and the generator.

### BRIEF DESCRIPTION OF THE DRAWINGS

The invention will become more apparent by reference to the following drawings, in conjunction with the accompanying specification, in which:

FIG. 1 is a top section view of an embodiment of the present invention that converts wind energy to mechanical or electrical energy with two generators;

FIG. 2 is a isometric view of the embodiment of FIG. 1 mounted on the roof of a structure;

FIG. 3 is an isometric section view of an embodiment of FIG. 1;

FIG. 4 is a top section view of an embodiment of the present invention that converts wind energy to mechanical or electrical energy with one generator;

FIG. 5 is a top section view of an embodiment of the present invention that converts wind energy to mechanical or electrical energy booster;

FIG. 6 is a top section view of an embodiment of FIG. 4 and FIG. 5;

In the drawings, like or similar elements are designated with identical reference numerals throughout the several views thereof, and the various elements depicted are not necessarily drawn to scale.

### DETAILED DESCRIPTION OF EMBODIMENTS

FIG. 1 is a top section view of an embodiment of the present invention that converts wind energy into electrical or mechanical energy. Louvers 1 are mounted on the exterior sides of the chamber 3. The function of the louvers 1 is to let the wind enter the chamber 3, redirect the wind as it enters the chamber 3 and prevent the wind from exiting the chamber 3. The wind travels through the chamber 3 and enters the duct 4 which feeds the wind into the generator 2. The wind then exits out through the generator 2.

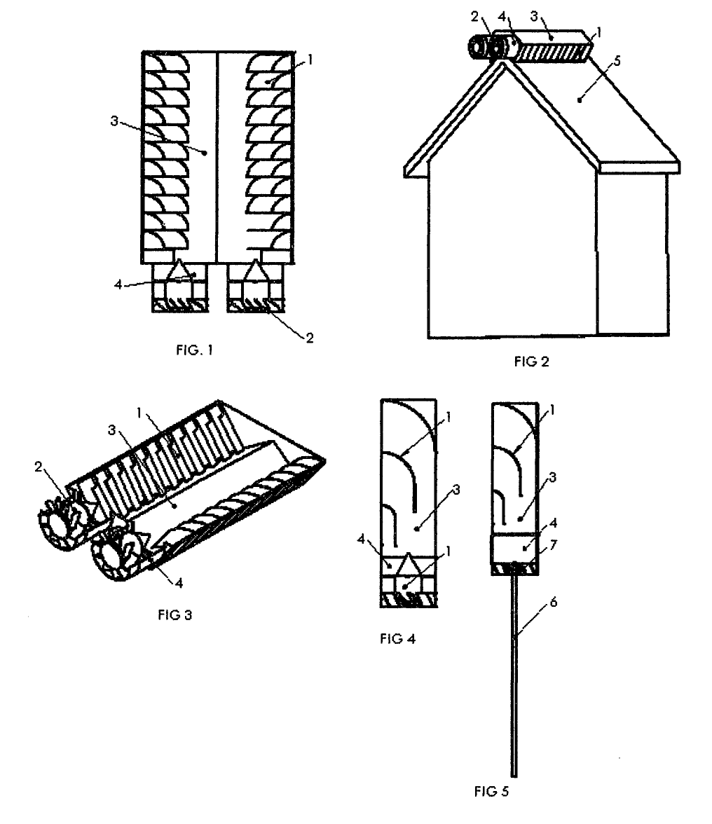

FIG. 2 is an isometric view of the embodiment of FIG. 1 mounted on a roof 5. FIG. 2 shows two generators 2 mounted on one chamber 3. This application would take advantage of the wind force generated by wind hitting the large area roof and redirected into the chamber 3 at the peak of the roof 5. This combination chamber takes advantage of wind from either direction.

FIG. 3 is an isometric section view of the embodiment of FIG. 1. This figure shows the top cut off exposing the internal workings of the invention. The louvers 1 are directed toward the end of the chamber which houses the generators 2.

FIG. 4 is a top section view of an embodiment of the present invention that converts wind energy to mechanical or electrical energy with one generator 2. This figure shows the top cut off exposing the internal working of the invention. The louvers 1 are progressively smaller channeling the wind without creating interference between the multiple channels 1.

FIG. 5 is a top section view of an embodiment of the present invention booster that converts wind energy to mechanical or electrical energy with no generator 2, but it does have a drive shaft 6 which connects to the generator 2 or a booster shaft 6 between the booster 7 and the generator 2. This figure shows the top cut off exposing the internal working of the invention. The louvers 1 are progressively smaller channeling the wind without creating interference between the multiple channels.

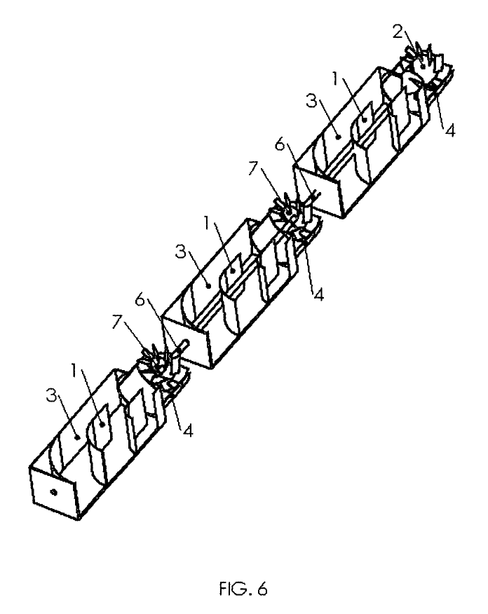

FIG. 6 is an isometric section view of an embodiment of the present invention that converts wind energy to mechanical or electrical energy with one generator 2 and two boosters 7. This figure shows the top cut off exposing the internal working of the invention. The louvers 1 are progressively smaller channeling the wind without creating interference between the multiple channels. The boosters 7 create rotational force which assists in turning the generator 2. The boosters 7 are connected to the generator 2 by means of a drive shaft 6.

The figures shown are just an example of one application for this invention and do not encompass all possibilities.

Even though, in the foregoing description many characteristics of the present invention have been described, the disclosure is illustrative only, the description being limited primarily to the aero- or hydrodynamic principles. Changes can be made, especially in matters of size, shape, number and arrangement of parts within the principles of the invention to the fill extent indicated by the applicant in the broadest coverage legally permissible.

What is claimed is:

1. A stationary wind or fluid scoop which captures and redirects wind or fluid for converting wind or fluid energy into electrical or mechanical energy, said device comprising of a chamber with one or more faces on said chamber which collect and redirect wind or fluid into said air or fluid duct, or directly into said air or fluid powered generator.

2. The stationary wind or fluid scoop which redirects wind or fluid direction and force for generating power in claim 1, and further comprising stationary louvers to redirect wind or fluid inside of said chamber. Said stationary louvers progressively change size and shape to optimize wind or fluid flow.

3. The stationary wind or fluid scoop which redirects wind or fluid direction and force for generating power in claim 1, and further comprising dynamic louvers to allow wind or fluid to enter said chamber.

4. The stationary wind or fluid scoop which redirects wind or fluid direction and force for generating power in claim 1, and further comprising dynamic louvers to prevent wind or fluid from exiting after entering said chamber.

5. The stationary wind or fluid scoop which redirects wind direction and force for generating power in claim 1, and further comprising of an add on boosters increasing power output. Said boosters will have the same components as the stationary wind or fluid scoop which redirects wind or fluid direction and force for generating power in claim 1 except said generator is replaced with a power generating fan device and a drive shaft connected between said booster power generating fan device and said generator. Said booster power generating fan will supply additional power to said generator by means of said drive shaft connecting said booster power generating fan device and said generator.
